(19) United States
(12) Patent Application Publication
(10) Pub. No.: US 2001/0025516 A1
(43) Pub. Date: Oct. 4, 2001

(54) Locking device

(76) Inventor: Harald Starken, Erdweg (DE)

Correspondence Address: Longacre & White, Suite 240, 6550 Rock Spring Drive, Bethesda, MD, 20817, US

(21) Appl. No.: 09/739,304

(22) Filed: Dec. 19, 2000

(30) Foreign Application Priority Data
Dec. 22, 1999 (DE) 19961975.1

(51) Int. Cl. F16C 3/00

(52) U.S. Cl. 70/186

(57) ABSTRACT

A locking device having at least one blocking element (6) displaced axially by an electromechanical drive (4) from a locking position into an unlocking position and vice versa. The locking device (1) comprising a control element (5) rotated by the electromechanical drive (4) that is positioned toward the blocking element (6) with a thread (11) that engages the control bolts (14), which are arranged in a transversely displaceable manner within the blocking element (6). The axial position of the control-bolt arrangement within the blocking element (6) is determined by the contour of the inner wall (17) of the control element (5). To displace the blocking element (6), the first end (12) of the control bolt (14) engages the thread turn (16) of the thread (11), while the second end (15) is supported on the inner wall (17) of the control element (5) located opposite the thread (11).

The invention relates to a locking device having at least one blocking element which can be displaced axially, by an electromechanical drive, from a locking position into an unlocking position and vice versa.

Such devices are usually used for locking and unlocking the steering spindle of a steering unit of a vehicle, but also, for example, for locking and unlocking doors or the like.

A corresponding device is known, for example, from DE 44 36 326 C1. This known device comprises a control element which can be rotated by the electromechanical drive and has two helical sloping members which extend about the axis of rotation of the control element and along which, upon rotation of the control element, two spring-activated control bolts, which are arranged in a transversely displaceable manner in the blocking element, slide and thus displace the blocking element from its locking position into its unlocking position. In the region of the two ends of the helical sloping members, the bearing and inner-wall regions of the control element are designed such that the spring-activated control bolts execute a freewheeling action in relation to the control element in these regions if, once the locking position or unlocking position of the blocking element has been reached, the control element continues to rotate in the corresponding direction. The blocking element is forced axially into its unlocking position by a compression spring which ensures that the two control bolts are forced into the sloping members if the control element is to be moved in the direction counter to the freewheeling direction of rotation and the blocking element is thus to be displaced into its locking position.

The disadvantage with this known device, inter alia, is that, on account of the two control bolts spaced apart by the spring, it takes up a relatively large amount of space. Moreover, the known control-bolt arrangement has relatively large friction radii, with the result that the resultant force on the blocking element is low.

Taking DE 44 36 326 C1 as departure point, the object of the invention is to specify a locking device with a more straightforward control-bolt arrangement.

This object is achieved according to the invention by the features of claim 1. Further, particularly advantageous configurations of the invention are disclosed in the subclaims.

The invention is essentially based on the idea of arranging in a transversely displaceable manner in the blocking element just a single control bolt, of which the respective axial position is determined by the contour of the inner wall of the control element. In order to displace the blocking element, the first end of the control bolt engages in the thread turn of a thread arranged in the control element, while the second end is supported on the control-element inner wall located opposite the thread. In the region of the thread ends, the control bolt come into contact with bearing surfaces and is positively controlled by the correspondingly configured inner wall of the control element such that the control element executes a freewheeling action relative to the axially spring-activated blocking element if, once the locking position or unlocking position of the blocking element has been reached, the control element continues to rotate in the corresponding direction.

In an advantageous embodiment of the invention, the control element comprises a drive element, which can be rotated by the electromechanical drive, and an actuating element, which is connected in a rotationally fixed manner to the drive element and contains the thread, the actuating element being arranged within the control element and being displaceable axially in relation to the same. On its side which is directed away from the blocking element, the actuating element has an axially displaceable cover on which there is supported a compression spring which is arranged between the actuating element and drive element. The length of the thread is selected such that, once the locking position or unlocking position of the blocking element has been reached, the control bolt is still located within the thread, with the result that upon continued rotation of the actuating element, with the blocking element located in the locking position, the actuating element is displaced in the direction of the compression spring and prestresses the same, and that upon continued rotation of the actuating element, with the blocking element located in the unlocking position, the compression spring is prestressed by the blocking element, which displaces the cover in the spring direction.

On the one hand, this embodiment gives the advantage that only a single compression spring is necessary even with the use of the positively controlled control bolt. On the other hand, this compression spring, at the same time, performs the so-called “ready to lock” function of the blocking element. This is because if, upon movement into the locking position—depending on the position of the steering spindle—the respective blocking element, rather than passing into a blocking groove formed, for example, by two teeth of a toothed ring, comes into contact with the tip of one of the teeth, then the locking spindle would not be locked if, in this position of the blocking element, the electric power supply of the electromechanical drive is switched off. Even with subsequent rotation of the steering wheel, the control bolt would not be forced into the blocking groove because the blocking element would obstruct such a displacement. It is thus customary (and, for example in the case of DE 44 36 326 C1, would also be necessary) for the blocking element to be designed in two parts in its region which is directed toward the respective steering spindle, and for the two parts to be coupled to one another by a spring. If, in this case, the front part of the blocking element comes into contact with a tip of a tooth, the continued displacement of the rear part prestresses the “ready to lock” spring, with the result that, upon subsequent rotation of the steering spindle, the front part of the blocking element is pushed into the blocking groove.

In the advantageous embodiment of the invention described above, then, the compression spring, which is necessary anyway for supporting the blocking element, also performs the function of the “ready to lock” spring since, when the blocking element comes into contact with a tip of a tooth, the actuating element is displaced in the direction of the compression spring and prestresses the same. Following rotation of the steering spindle, the compression spring then displaces both the actuating element and blocking element, which is connected to the actuating element, in the direction of the locking groove.

Further details and advantages of the invention can be gathered from the following exemplary embodiments explained with reference to figures, in which:

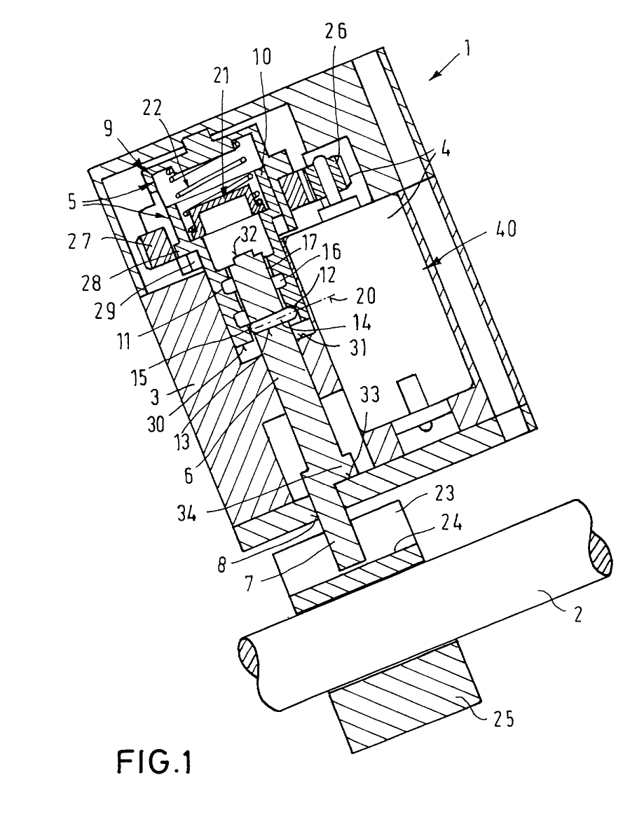

FIG. 1 shows a longitudinal section through a device according to the invention with a blocking element, the blocking element being located in its locking position;

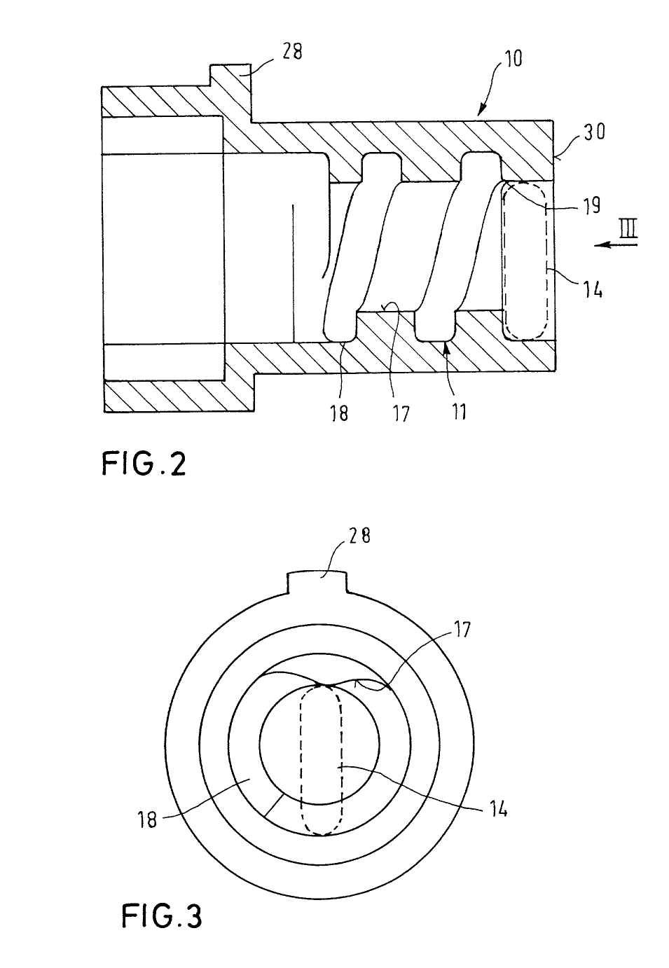

FIG. 2 shows a longitudinal section through an actuating element, which actuates the blocking element;

FIG. 3 shows a side view of the actuating element illustrated in FIG. 2 from the side designated III; and

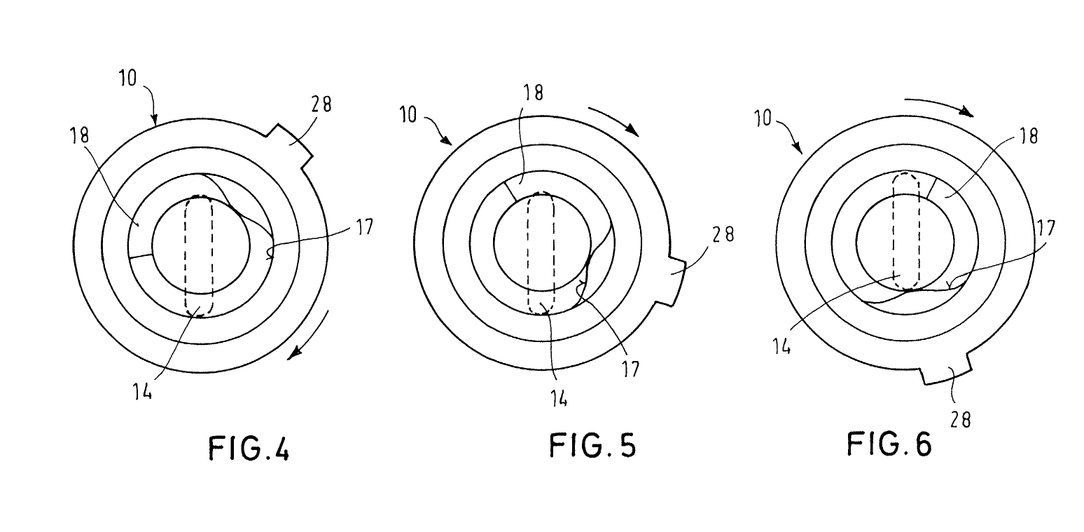

FIGS. 4-6 show three further side views corresponding to FIG. 3, with different angles of rotation of the actuating element.

In FIG. 1, 1 designates a locking device for locking the steering spindle 2 of a steering unit of a motor vehicle. The locking device 1 comprises a housing 3 in which there is arranged an electromechanical drive 4 with an electric motor 40 with a reversible direction of rotation, which, via a control element 5, causes axial displacement of a blocking element 6, which can be displaced from a locking position into an unlocking position and vice versa. In its region 7, which is directed toward the steering spindle 2, the blocking element 6 has a rectangular cross section and is guided through a rectangular recess 8 of the housing 3, with the result that rotation of the blocking element 6 about its longitudinal axis is not possible.

The control element 5 comprises a drive element 9 and an actuating element 10, which is connected in a rotationally fixed manner to the drive element 9, is arranged within the drive element 9 and can be displaced axially in relation to the same. On its side which is directed toward the blocking element 6, the actuating element 10 has a thread 11 in which there engages the first end 12 of a control bolt 14, which is arranged in a displaceable manner in a transverse bore 13 of the blocking element 6 and of which the second end 15 is positively guided in the radial direction by the inner wall 17 of the actuating element 10 located opposite the thread turn 16.

In the region of the two thread ends 18, 19 (FIG. 2), the inner wall 17 of the actuating element 10 has a contour (FIG. 3) which is designed such that the control bolt 14, which is positively guided by the inner wall 17, executes a freewheeling action in these regions if, once the locking position or unlocking position of the blocking element has been reached, the actuating element 10 continues to rotate in the corresponding direction. In this case, the control bolt 14 is displaced back and forth in the direction of its longitudinal axis 20 (see also FIGS. 3-6; the control bolt 14 is illustrated by dashed lines in these figures).

On its side which is directed away from the steering spindle 2, the actuating element 10 has an axially displaceable cover 21 (FIG. 1) on which there is supported a compression spring 22 which is arranged between the actuating element 10 and drive element 9.

The length of the thread 11 is selected such that, once the locking position of the blocking element 6 has bee reached, the control bolt 14 is still located within the thread 11 and also, once the locking position has been reached, the actuating element 10 and/or the blocking element 6 can continue to be displaced axially in order to produce prestressing of the compression spring 22.

If, in contrast, the blocking element 6 is displaced into the unlocking position, then the cover 21 is displaced by the blocking element 6 counter to the compression spring 22 such that, when the unlocking position is reached, the compression spring is prestressed.

The functioning of the locking device 1 according to the invention will be discussed hereinbelow. Let us assume here that the blocking element 6 is located in the locking position, which is illustrated in FIG. 1, with the result that its front end 7 engages in a blocking groove 24, which is formed by two adjacent teeth 23 and belongs to a toothed ring 25 fastened on the steering spindle 2, and the actuating element 10 has been displaced in the direction of the compression spring 22 and thus prestresses the spring.

If, then, the electric motor 40 is activated, in order to displace the blocking element 6 into its unlocking position, the electric motor 40 rotates the drive element 9 via a driving pinion 26, said drive element having, for this purpose, an outer toothing arrangement 27 on its circumference. The rotary movement of the drive element 9 is transmitted to the actuating element 10 via a protrusion 28, which is arranged on the actuating element 10 and engages in a corresponding axial longitudinal groove 29 of the drive element 9. As a result, the actuating element 10 is displaced helically along the blocking element 6 until such time as it strikes, by way of its front end side 30, against a first stop 31 on the housing.

Upon continued rotation of the actuating element 10, during which the latter cannot be displaced any further in the direction of the steering spindle 2, the blocking element 6 is drawn out of the blocking groove 24 of the toothed ring 25. In this case, the end 32 of the blocking element 6, said end being directed away from the steering spindle 2, strikes against the cover 21, displaces the latter and thus prestresses the compression spring 22 until such time as the control bolt 14 has reached the thread end 18, and the actuating element 10 then executes a freewheeling movement. The blocking element 6 has reached its unlocking position and the electric motor 40 can be switched off, for example via a contact switch which, for reasons of clarity, is not illustrated.

In order to lock the steering spindle 2, the electric motor 40 is activated again, the driving pinion 26 and thus also the control element 5 being rotated in the opposite direction. By virtue of the pressure of the prestressed compression spring 22, the control bolt 14 is forced into the thread 11 of the rotating actuating element 10, with the result that the blocking element 6 is displaced into its blocked position. In this case, the actuating element 10 is initially still located on the first stop 31. If a front protrusion 34 of the blocking element 6 then reaches a second stop 33 on the housing (or if the blocking element presses against the base of the blocking groove 24) and thus cannot be displaced any further in the locking direction, then the actuating element 10 is displaced in the direction of the compression spring 22 until such time as the control bolt 14 has reached the thread end (FIG. 2) and the actuating element 10 again executes a freewheeling action (the movement sequence of the control bolt corresponds to the sequence illustrated in FIGS. 3-6). The electric motor is then switched off, for example by a further contact switch (not illustrated).

1. A locking device having at least one blocking element (6) which can be displaced axially, by an electromechanical drive (4), from a locking position into an unlocking position and vice versa, having the following features:
a) the locking device (1) comprises a control element (5) which can be rotated by the electromechanical drive (4) and, on its side which is directed toward the blocking element (6), has a thread (11) in which there engages the first end (12) of a control bolt (14), which is arranged in a transversely displaceable manner in the blocking element (6) and of which the second end (15) is positively guided in the radial direction by the inner wall (17) of the control element (5) located opposite the respective thread turn (16);
b) in the region of the two thread ends (18, 19), the inner wall (17) of the control element (5) I s designed such that the control bolt (14), which is positively guided by the inner wall (17), executes a freewheeling action in relation to the control element (5) in these regions if, once the locking position or unlocking position of the blocking element (6) has been reached, the control element (5) continues to rotate in the corresponding direction;
c) the blocking element (6) is spring-activated in the axial direction both in its locking position and in the unlocking position, such that, when the control element (5) is rotated in the direction counter to the freewheeling direction of rotation, the control bolt (14) is forced axially into the thread (11).

2. The locking device as claimed in claim 1,
wherein the control element (5) comprises a drive element (9), which can be rotated by the electromechanical drive (4), and an actuating element (10), which is connected in a rotationally fixed manner to the drive element (9) and contains the thread (11), the actuating element (10) being arranged within the drive element (9) and being displaceable axially in relation to the same;
wherein, on its side which is directed away from the blocking element (6), the actuating element (10) has an axially displaceable cover (21) on which there is supported a compression spring (22), of which the other end is supported on the drive element (9);
wherein the length of the thread (11) is selected such that, once the locking position of the blocking element (6) has been reached, the control bolt (14) is still located within the thread (11), with the result that upon continued rotation of the actuating element (10), with the blocking element (6) located in the locking position, the actuating element (10) is displaced in the direction of the compression spring (22) and prestresses the same.

3. The locking device as claimed in claim 1, wherein, upon movement of the blocking element (6) into the unlocking position, the cover (21) is displaced by the blocking element (6) counter to the pressure of the compression spring (22) such that, when the unlocking position is reached, the compression spring (22) is prestressed.

4. The locking device as claimed in claim 1, wherein the blocking element (6) has a front protrusion (34) which, when the locking position of the blocking element (6) is reached, is forced against a stop (33) of a housing (3) which at least partially encloses the device.

5. The locking device as claimed in claim 1, wherein the electromechanical drive (4) comprises an electric motor (40) with reversible direction of rotation.

6. The locking device as claimed in claim 1, wherein the electromechanical drive (4) comprises a driving pinion (26) which engages in an outer toothing arrangement (27) of the control element (5).
